(19) United States
(12) Patent Application Publication
(10) Pub. No.: US 2003/0217765 A1
(43) Pub. Date: Nov. 27, 2003

(54) Structure of a vehicle maintenance washing apparatus

(76) Inventor: Tu Tsung Chuan, Taipei (TW)

Correspondence Address: TU Tsung Chuan, PO Box 82-144, Taipei, TW

(21) Appl. No.: 10/153,785

(22) Filed: May 24, 2002

(51) Int. Cl. B60S 3/00; B08B 9/00

(52) U.S. Cl. 134/111; 134/169 A

(57) ABSTRACT

An improved structure of a vehicle maintenance and washing apparatus is disclosed and the apparatus comprises an air compressor with a pulse pump as a driven source, a one check valve, an engine oil fine filter, at least one or a plurality of strainers, a plurality of three way joints, a plurality of four way joints and a plurality of butterfly valves, characterized an inlet/outlet oil tube and a solvent tube are mounted thereof and the inlet oil tube passes the 1^{st} four way joint and then divides into two routes, the 1^{st} route inlet oil tube may or may not pass the strainer connecting the 2^{nd} four way joint, and the 2^{nd} route inlet oil tube passes the engine oil fine filter, the 3^{rd} butterfly valve and the 1^{st} three way joint and is then connected to the pulse pump, the solvent tube connected to the 4^{th} butterfly valve passes the 2^{nd} three way joint and the 1^{st} three way joint and enters the pulse pump outlet oil tube and from the pulse pump to the one check valve connecting the 2^{nd} four way joint, and from the 2^{nd} four way joint to the external, the inlet/outlet oil tube is connected to engine lubricating system, or ejector or auto gearshift box which needed to be cleaned.

### BACKGROUND OF THE INVENTION

1. Field of the Invention

The present invention relates to an improved structure of vehicle maintenance and washing apparatus, and in particular, an apparatus with multi purposes. The apparatus can be used for washing an engine ejector, a lubricating system and an auto gearshift box.

2. Description of the Prior Art

The excessive temperature of the combustion chamber of a vehicle engine after driving will cause gasoline residue at the engine ejector, which will be formed into accumulated carbon. The carbon hinders the atomizing gasoline even no gasoline is atomized and the power of the engine will be lost. This will also increases the oil consumption and affects the quality of exhausted discharge. Moreover, when the engine oil is changed, the exhausted oil in the engine may not be drained completely. The run-in period of a new vehicle will generate alloy powder, and excessive heat of the engine while in driving will generate carbon particles and etc. There may not only make the boss motion and the piston reciprocation movement to produce friction, but it may also increase the engine oil temperature, damaging the engine oil coating functioned to protect the engine.

Furthermore, a vehicle running for an extended period, despite periodic maintenance, the exhausted oil inside its torque rotary apparatus is unable to change totally.

### SUMMARY OF THE INVENTION

Accordingly, it is an object of the present invention to provide an improved structure of a vehicle washing apparatus, comprising an air compressor with a pulse pump, a one check valve, an engine oil fine filter, a non to a plurality of strainers, three units of three way joints, two units of four way joints, and five units of butterfly valves and other components. There is also constructed and assembled with an inlet/outlet oil tube and a solvent tube. The inlet oil tube passes the 1^{st} four way joint and then divided into two routes. The 1^{st} route is passed the strainer connecting the 2^{nd} four way joint, the 2^{nd} route is passed the engine oil fine filter, the 3^{rd} butterfly valve and the 1^{st} three way joint and connecting the pulse pump. The solvent tube route relates to a solvent pail is passed the 4^{th} butterfly valve connecting the 2^{nd} three way joint, and the 1^{st} three way joint, and passed the 1^{st} butterfly valve connecting the 3^{rd} three way joint. The outlet oil tube is from the pulse pump passed through the one check valve connecting the 2^{nd} four way joint, then again from the 2^{nd} four way joint is connected it out. The pulse force of the pulse pump, the one check valve and each butterfly valve are under controlled for washing the outlet oil tube connecting of the engine lubricating system, or the spray oil nozzles or the auto gearshift box. There may not only structure wise become three engines into one to save cost, but also the structure of the pulse pump may generate the pulse force such that it effectively wash the dirt, and the fine filter may also filter those particles dirt after washed. It not only can reach the application effect on the washing maintenance, but also increase the engine working efficiency and reduce the exhaust gas discharge quantity.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an external plan view of the present invention.

FIG. 2 is a schematic view showing the components and assembly of the tubes routes of the present invention.

FIG. 3 is a schematic view showing the washing for the engine lubricating system of the present invention.

FIG. 4 is a schematic view showing the washing for the spray oil nozzle of the present invention.

FIG. 5 is a schematic view showing the washing for the auto gearshift box of the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

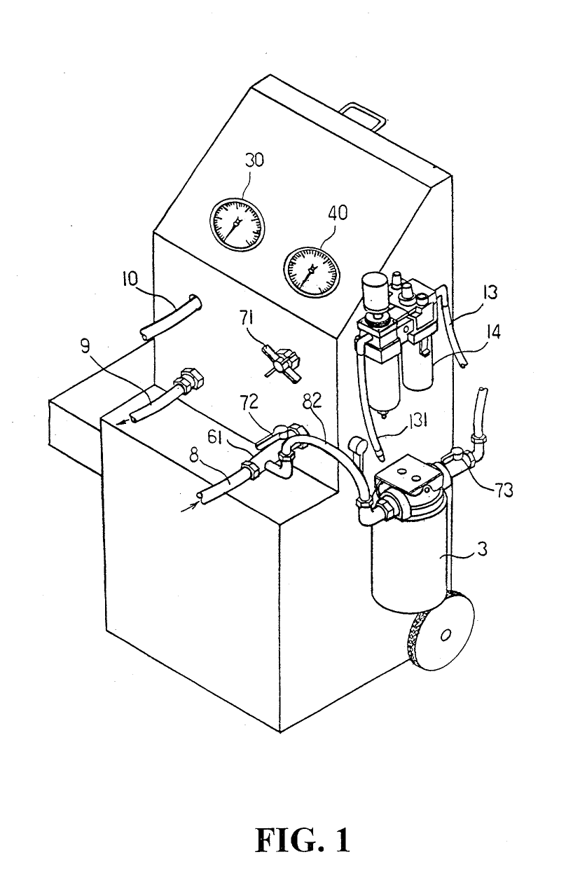

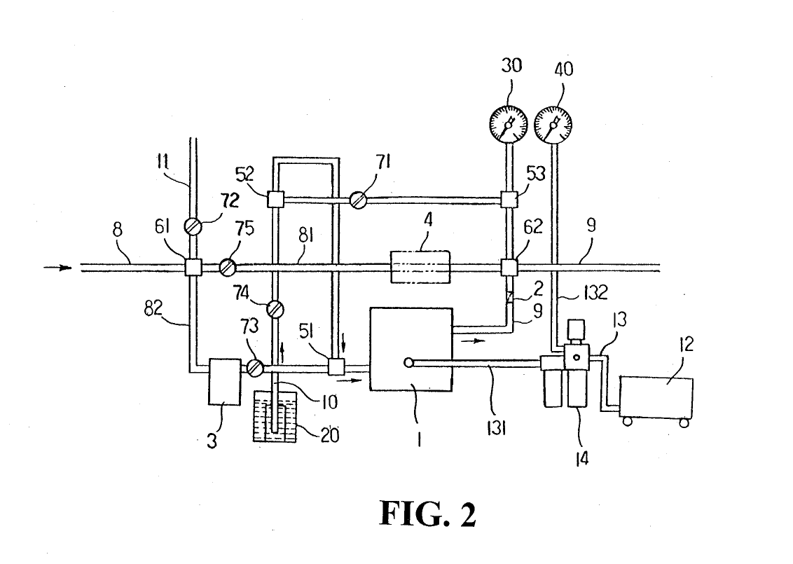

Referring to FIG. 1 and FIG. 2, an improved structure of a vehicle 110 maintenance washing apparatus of the present invention is disclosed. The apparatus comprises a pulse pump 1, a one check valve 2, an engine oil fine filter 3, a plurality of strainers 4, three units of three way joints 51, 52, 53, two units of four way joints 61, 62, and five units of butterfly valves 71, 72, 73, 74, 75 and other components. The apparatus may also be constructed and assembled with an inlet/outlet oil tube 8/9 and a solvent tube 10 and a drain oil tube 11.

The inlet oil tube 8 is connected to the 1^{st} four way joint 61 and then divided into the 1^{st} route inlet oil tube 81 and 2^{nd} route inlet oil tube 82. The 1^{st} route inlet oil tube 81 is connected to the 5^{th} butterfly valve 75 and the strainer 4 connecting the 2^{nd} four way joint 62. The 2^{nd} route inlet oil tube 82 is connected to the engine oil fine filter 3, the 3^{rd} butterfly valve 73 and the 1^{st} three way joint 51 and connected to the pulse pump 1. The outlet oil tube 9 from the pulse pump 1 is connected through the one check valve 2 connecting the 2^{nd} four way joint 62, then the 2^{nd} four way joint 62 is connected such that it is connected to the washing components. The solvent tube 10 mounted with a solvent pail 11 is connected to the 4^{th} butterfly valve 74. The 2^{nd} three way joint 52 and the 1^{st} three way joint 51 enter the pulse pump 1. The drain oil tube 11 related to the 1^{st} four way joint 61 is connected to the 2^{nd} butterfly valve 72, which is used for the draining of dirty oil.

The 3^{rd} three way joint 53 is also connected to an oil pressure gauge 30, showing the oil pressure. An air compressor 12 is the driven source used in accordance with the present invention. The air pressure tube 13 from the air compressor 12 having being connected to an air-regulating module 14 is connected to the pulse pump 1 by an air pressure 1^{st} tube 131 and an air pressure 2^{nd} tube 132 is connected to a pressure gauge 40, showing the air pressure.

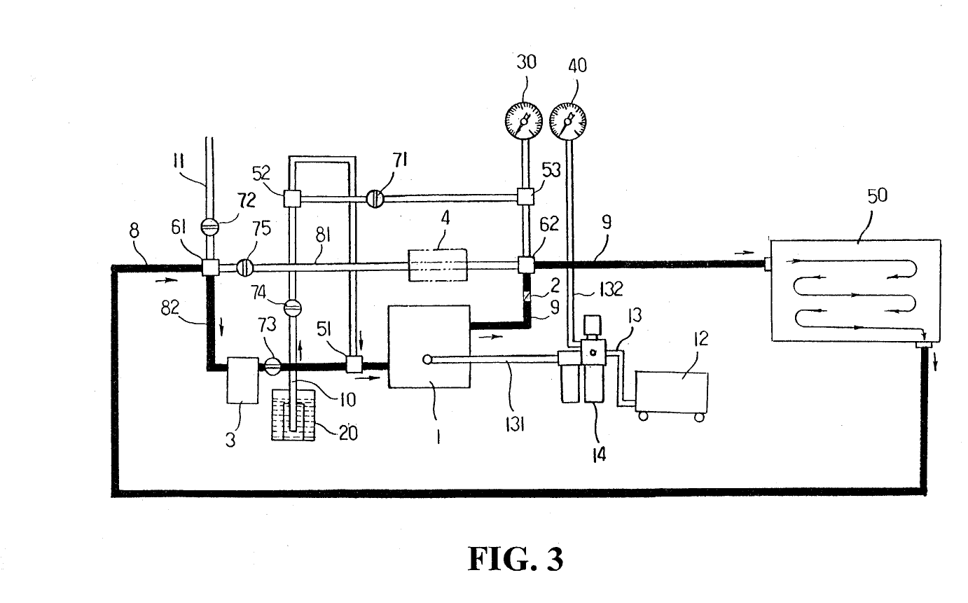

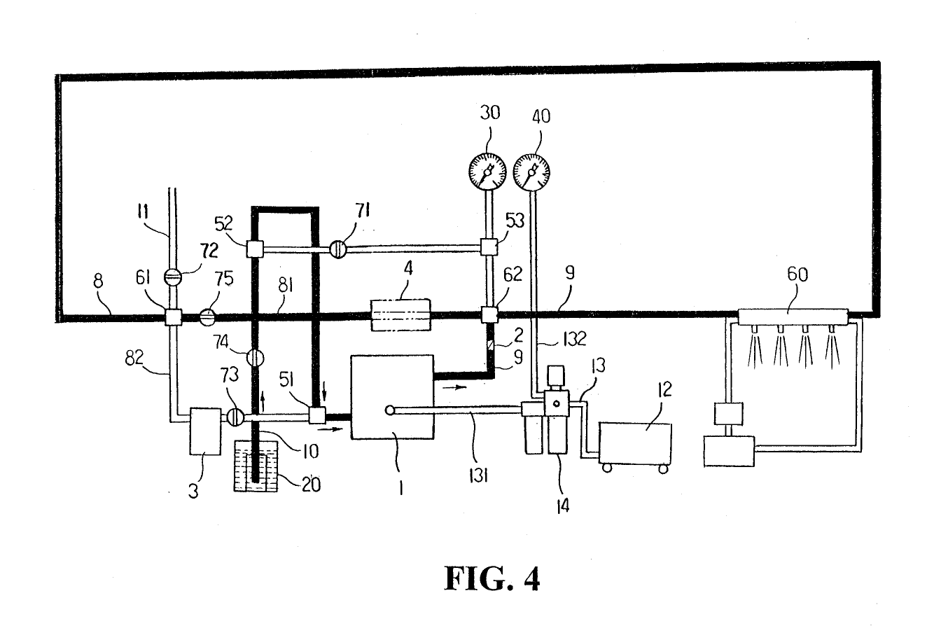

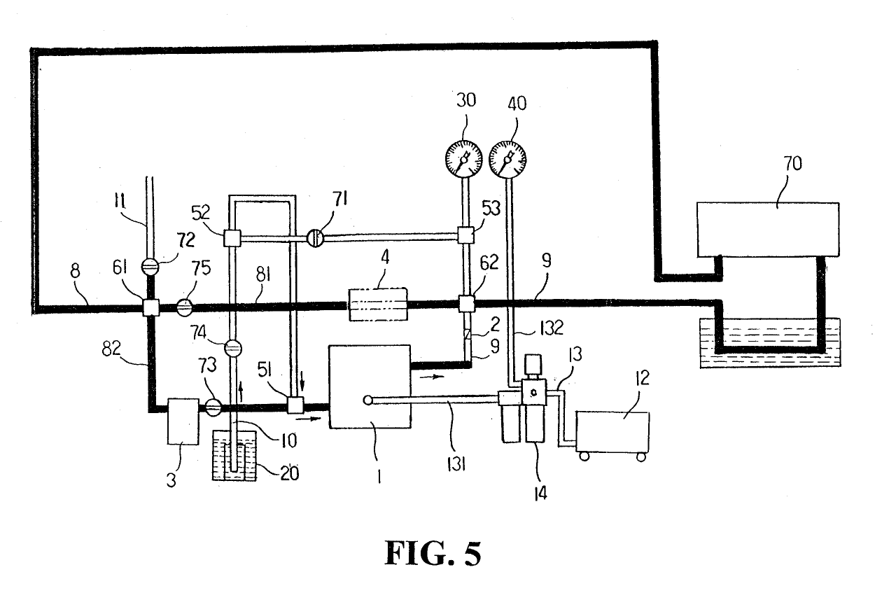

Referring to FIG. 3, FIG. 4 and FIG. 5, the inlet/outlet oil tube 8/9 is connected to all the engine lubricating system 50 or the spray oil nozzle 60 or the auto gearshift box 70 and other washing components, together with the application of butterfly valves 71, 72, 73, 74, 75, the pulse pump 1 will provide the washing solvent in the solvent pail 20 from the solvent tube 10 passed the 4^{th} butterfly valve 74, the 2^{nd} three way joint 52 and the 1^{st} three way joint 51 entering into the pulse pump 1. The outlet oil tube 9 will enter the washing components to accomplish the washing and maintenance.

When washing the engine lubricating system 50 (referring to FIG. 3), close the 5^{th} butterfly valve 75, the washing solvent from the inlet oil tube 8 is passed to the 1^{st} four way joint 61, and from the 2^{nd} route of the inlet oil tube 82, to the engine oil fine filter 3. Then, again, from the 3^{rd} butterfly valve 73 (open), the 1^{st} three way joint 51 enter the pulse pump 1. Again, the outlet oil tube 9 passes the one check valve 2 and the 2^{nd} four way joint 62 enters the engine lubricating system 50 to proceed with recycling of the filter washing. It does not care whether the engine is over heated while driving as a result of generating the carbon particles from the engine oil or the run-in period of the new vehicle, generating alloy powder. The engine can be cleaned through the pulse force of the pulse pump, such that the cause of the boss motion and the friction of the piston reciprocating momentum can be removed.

When washing the ejector 60 (refer to the FIG. 4), close the 3^{rd} butterfly valve 73, the solvent tube 10 from the solvent pail 20 passes the 4^{th} butterfly valve 74 (open), the 2^{nd} three way joint 52 and the 1^{st} three way joint 51 enter the pulse pump 1. Again, it passes the one check valve 2, the 2^{nd} four way joint 62, and the outlet oil tube 9 enters the ejector 60 to proceed with the recycle of washing thereof. Thus, the pulse force of the pulse pump will clean away the accumulated carbon, which affects atomizing.

When washing the auto gearshift box 70 (refer to FIG. 5), open the 5^{th} butterfly valve 75 and the 3^{rd} butterfly valve 73, close the 4^{th} butterfly valve 74, the 1^{st} butterfly valve 71 and the 2^{nd} butterfly valve 72. When in recycling, the washing solvent from the inlet oil tube 8 is passed the 1^{st} four way joint 61, the 5^{th} butterfly valve 75 and the 2^{nd} four way joint 62 and then from the outlet oil tube 9 is entered into the auto gearshift box 70. When the pulse pump 1 is in action, the auto oil passes the engine oil fine filter 3, the 3^{rd} butterfly valve 73, and the 1^{st} three way joint 51 and enters the pulse pump 1 and generate the pulse force. Again, it passes through the one check valve 2; the 2^{nd} four way joint 62 and the outlet oil tube 9 will enter into the auto gearshift box 70 and generating the recycle of washing. After washing, open the 2^{nd} butterfly valve 72 to drain off the exhausted oil, and from the oil scale port, new auto oil is introduced to replace the exhausted oil. The new oil shall be 5 liters.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a vehicle maintenance and washing apparatus comprising an air compressor with a pulse pump as a driven source, a one check valve, an engine oil fine filter, at least one or a plurality of strainers, a plurality of three way joints, a plurality of four way joints and a plurality of butterfly valves, characterized an inlet/outlet oil tube and a solvent tube are mounted thereof and the inlet oil tube passes the 1^{st} four way joint and then divides into two routes, the 1^{st} route inlet oil tube may or may not pass the strainer connecting the 2^{nd} four way joint, and the 2^{nd} route inlet oil tube passes the engine oil fine filter, the 3^{rd} butterfly valve and the 1^{st} three way joint and is then connected to the pulse pump, the solvent tube connected to the 4^{th} butterfly valve passes the 2^{nd} three way joint and the 1^{st} three way joint and enters the pulse pump outlet oil tube and from the pulse pump to the one check valve connecting the 2^{nd} four way joint, and from the 2 four way joint to the external, the inlet/outlet oil tube is connected to engine lubricating system, or ejector or auto gearshift box which needed to be cleaned.
